(19) United States
(12) Patent Application Publication
(10) Pub. No.: US 2009/0046033 A1
(43) Pub. Date: Feb. 19, 2009

(54) Digital Collage Display System

(75) Inventor: Jeffrey Siegel, Kings Point, NY (US)

Correspondence Address: TROUTMAN SANDERS LLP, 600 PEACHTREE STREET , NE, ATLANTA, GA, 30308, US

(73) Assignee: Lifetime Brands, Inc., Garden City, NY (US)

(21) Appl. No.: 11/960,245

(22) Filed: Dec. 19, 2007

Related U.S. Application Data
(60) Provisional application No. 60/956,010, filed on Aug. 15, 2007.

(51) Int. Cl. G09G 5/00; G06F 1/16

(52) U.S. Cl. 345/1.3; 345/1.1; 361/681

(57) ABSTRACT

The present invention describes methods and apparatus to efficiently and effectively provide for the convenient and simultaneous display of multiple digital images. An exemplary embodiment of the present invention provides a digital collage display system having a housing. A first electronic display device is provided in communication with the housing, and a second electronic display device is provided in communication with the housing. Further, the digital collage display system includes a memory device in communication with the first electronic display device and the second electronic display device. The first electronic display device and the second electronic display device are enabled to display a plurality of digital images stored on the memory device.

### CROSS REFERENCE TO RELATED APPLICATION

This application claims the benefit of U.S. Provisional Application No. 60/956,010, filed 15 Aug. 2007, which is hereby incorporated by reference in its entirety as if fully set forth below.

### FIELD OF THE INVENTION

This invention relates generally to the field of digital image display systems, and specifically to systems and methods to conveniently and simultaneously display multiple digital images.

### BACKGROUND OF THE INVENTION

Advancements in digital imaging technology have enabled consumers to conveniently capture, store, and share thousands of digital photographs. As there are minimal costs associated with film or photo processing, digital imaging equipment allows consumers to capture large numbers of images with little or no incremental expense. Additionally, commonly available electronic transmission means, including email, internet, and wireless distribution, allow consumers to inexpensively and conveniently transmit and receive a large number of images from friends and family.

As the size of consumers' personal digital image libraries grow, demand increases for convenient ways to easily and prominently display portions of their large libraries of digital images. Furthermore, consumers desire ways to display these images in an aesthetically pleasing manner. Additionally, consumers desire methods and devices of displaying multiple pictures at one time. The ability to display more than one image enables the consumer to tell a story, share an event, or highlight an individual or object.

For decades, prior art systems and devices have attempted to address the desire of the consumers to conveniently, easily, and aesthetically display multiple pictures. Multi-slot frames have long been available to allow users to display conventional hard copy photography. For example, U.S. Pat. No. 1,553,471, filed Mar. 25, 1925, discloses a conventional picture frame for hardcopy photographs. The picture frame shown in FIG. 1A of this patent has multiple openings of various sizes for a variety of pictures. Thereby, this picture frame enables an entire set of hard copy photographs to be displayed at one time.

As with hard copy photographs, consumers also desire a way to display multiple images from their digital cameras. U.S. Patent Publication No. 2006/0192791, published Aug. 31, 2006, discloses an apparatus for creating a digital photo album. A software application is described that displays a group of images for which corresponding image files are available, prompts the user to select a plurality of images from the group, and saves the selected images to a storage medium as an album of images. The software can then perform a number of steps to process the album, including making a copy of each image, making a contact sheet, and compressing the images. The application discloses that the software can be run on a personal computer, and displayed on a computer monitor, or be run on set-top box and displayed on a television.

U.S. Patent Publication No. 2006/0220983 (“'983 Publication”), published on Oct. 5, 2006, discloses a method and apparatus for generating an album while adequately allocating images per page in accordance with image capturing times. The invention provides a distribution-of-image-capturing-time calculating section for calculating a distribution of image capturing-times of the plurality of images stored in an image storing section. The image sorting section may sort the images so that the number of images on each page of the album generated by the invention are almost equalized. Additionally, the '983 Publication discloses that the image sorting section is enabled to sort by various other parameters, including image location and subject. FIG. 2 of the '983 Publication illustrates an album that displays a main image and multiple supporting images in one layout.

U.S. Patent Publication No. 2007/0035470 (“'470 Publication”), issued Feb. 15, 2007, provides a method of dynamically configuring a physical display device. The '470 Publication discloses an apparatus with a mapping block 230 enabled to configure a number of logical screens 210 and 212 onto a display screen 220. The mapping block 230 can change the size and aspect ratio of the logical screen in accordance with the position and placement on the display screen. FIGS. 1A-1H illustrate how the mapping block 230 can arrange multiple logical screens onto one display screen. The '470 Publication disclosure focuses on television displays, and more particularly Picture-In-Picture services on televisions.

U.S. Patent No. 2004/0126061 (“'061 Publication”), issued Jun. 16, 2005, provides a digital photo display having a memory card port and a screen. The memory card port of the '061 Publication is electrically connected to a main control circuit, which is also connected to the screen, and the main control circuit enables pictures stored a memory card inserted into the memory card port to be displayed on the screen. Additionally, the '061 Publication discloses that the digital photo display be provided with a frame around the screen, which can be hung for display. The user is enabled to cycle through photos on the digital photo display through the use of control buttons.

Despite a wide variety of display devices in the prior art, the most prominent method of displaying digital image libraries remains to be the use of a computer monitor to display images. The use of computer monitor as a digital image library display device poses many problems for the consumer. For example, a consumer's computer and monitor are often located in an office of the home, which is most often not centrally located within the home and is a relatively inconvenient area for access by guests. Additionally, the central purpose of the computer is often not for displaying pictures, but rather email, Internet access, and other computing tasks. Thus, the computer most often cannot serve the dedicated purpose of displaying pictures. Therefore, when the consumer desires to display images, he must activate a program to perform the digital image display function.

While suitable for their intended purposes, the devices and systems of the prior art do not provide a convenient and effective means of displaying digital images. Additionally, a majority of the prior art devices that provide a dedicated digital image display only permit the display of one image at a time. Therefore, it is highly desired to provide a digital collage display system capable of providing an efficient and effective method of displaying multiple digital images.

Additionally, it is highly desired to provide a digital collage display system capable of being centrally located in a home or office environment.

Additionally, it is highly desired to provide a digital collage display system capable of being dedicated to the display of digital images.

Additionally, it is highly desired to provide a digital collage display system capable of providing an attractive aesthetic.

### BRIEF SUMMARY OF THE INVENTION

The present invention describes methods and apparatus to efficiently and effectively provide for the convenient and simultaneous display of multiple digital images. An exemplary embodiment of the present invention provides a digital collage display system having a housing. A first electronic display device is provided in communication with the housing, and a second electronic display device is provided in communication with the housing. Further, the digital collage display system includes a memory device in communication with the first electronic display device and the second electronic display device. The first electronic display device and the second electronic display device are enabled to display a plurality of digital images stored on the memory device.

These and other objects, features and advantages of the present invention will become more apparent upon reading the following specification in conjunction with the accompanying drawing figures.

### BRIEF DESCRIPTION OF THE FIGURES

FIG. 1A provides a block diagram of a digital collage display system 100 in accordance with an exemplary embodiment of the present invention.

FIG. 1B provides a block diagram of a digital collage display system 100 in communication with remote devices in accordance with an exemplary embodiment of the present invention.

FIG. 2 provides a block diagram of a digital collage display system 100 in accordance with an exemplary embodiment of the present invention.

FIG. 3 provides a perspective view of a digital collage display system 100 in accordance with an exemplary embodiment of the present invention.

FIG. 4 provides a perspective view of a digital collage display system 100 in accordance with an exemplary embodiment of the present invention.

### DETAILED DESCRIPTION OF PREFERRED EMBODIMENTS

To facilitate an understanding of the principles and features of the invention, it is explained hereinafter with reference to its implementation in an illustrative embodiment. In particular, the invention is described in the context of being a digital collage display system capable of efficiently and effectively providing the convenient and simultaneous display of multiple digital images.

The device components described hereinafter as making up the various elements of the invention are intended to be illustrative and not restrictive. Many suitable components that would perform the same or a similar function as the components described herein are intended to be embraced within the scope of the invention.

The present invention addresses the deficiencies of the prior art with respect to the ability to provide for the convenient display of digital images. In an exemplary embodiment, the present invention provides a digital collage display system having a housing. A first electronic display device is provided in communication with the housing, and a second electronic display device is provided in communication with the housing. Further, the digital collage display system includes a memory device in communication with the first electronic display device and the second electronic display device. The first electronic display device and the second electronic display device are enabled to display a plurality of digital images stored on the memory device.

In addition to digital collage display systems, the present invention provides a method of creating a digital image collage involving providing a housing having a first electronic display device and second electronic display device. Furthermore, the method includes providing a memory device in communication with the first electronic display device and the second electronic display device, and displaying a plurality of digital images stored on the memory device on the first electronic display device and the second electronic display device.

Referring now to the figures, wherein like reference numerals represent like parts throughout the figures, the various exemplary embodiments of the digital collage display system will be described in detail.

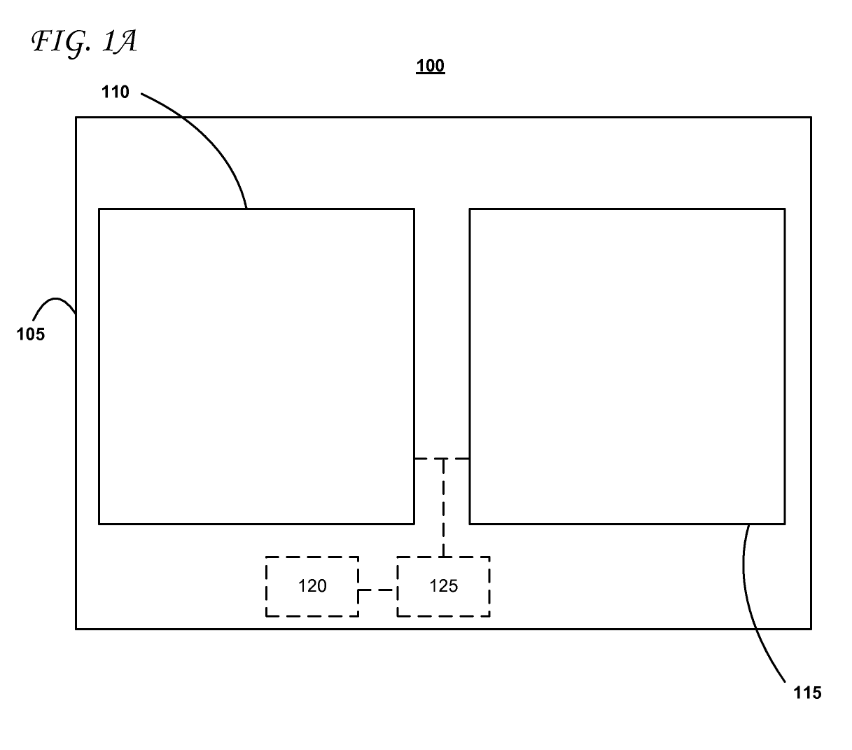

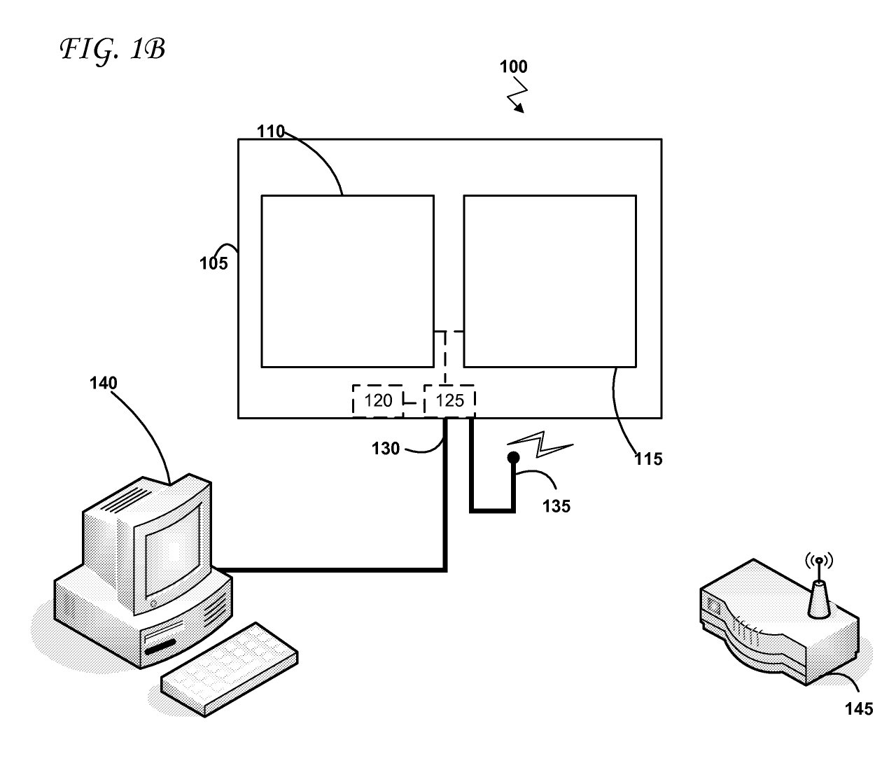

FIG. 1A provides a block diagram of a digital collage display system 100 in accordance with an exemplary embodiment of the present invention. The digital collage display system 100 shown in FIG. 1A provides a housing 105. Those of skill in the art will appreciate that the housing 105 can be a variety of suitable apparatus, including a frame, box, shell, wire structure, cabinet, or other support structure. The housing 105 can be a standard picture frame modified for the purposes of an exemplary embodiment of the digital collage display system 100 or a housing manufactured particularly for a digital collage display system 100. In an exemplary embodiment of the digital collage display system 100, a first electronic display device 110 is provided in communication with the housing 105. In an exemplary embodiment, the first electronic display device 110 can be mounted within the housing 105, such that it occupies a portion of the total area defined by the housing 105. Additionally, in an exemplary embodiment of the digital collage display system 100, a second electronic display device 115 is provided in communication with the housing 105. As with the first electronic display device 110, the second electronic display device 115 can be mounted within the housing 105, such that it occupies a portion of the total area defined by the housing 105. Therefore, both the first electronic display device 110 and the second electronic display device 115 are contained within the housing 105.

In an exemplary embodiment, the digital collage display system 100 further provides a memory device 120 in communication with the first electronic display device 110 and the second electronic display device 115. This memory device 120 is capable of storing multiple digital images, movies, or other data. In an exemplary embodiment, the digital collage display system 100 is configured to enable the electronic display devices 110 and 115 to display the digital images, movies, or other data. Furthermore, in an exemplary embodiment, the digital collage display system 100 can be provided with a processor 125 to retrieve data from the memory device and enable it to be communicated to the electronic display devices 110 and 115 for display. The processor 125 can be many different types of microprocessors capable of retrieving and transmitting data files for exhibition. The processor 125 can rely upon a variety of different types of communication and data transfer links to retrieve data from the memory device 120 and transmit it to the electronic display devices 110 and 115. Those of skill in the art appreciate that both the memory device 120 and the processor 125 can provided within the housing 105 of the digital collage display system 100, or could be provided external to the housing 105 and relay data to the electronic display devices 110 and 115 via a wired or wireless link.

With respect to the memory device 120, those of skill in the art will appreciate it can be a variety of different types of memory devices. For example, but not limitation, the memory device 120 could be a flash media card from a digital camera or other piece of digital imaging equipment. In an exemplary embodiment, the digital collage display system 100 can provide a memory card slot in the housing 105. For this embodiment, a user can insert a flash media card into the memory card slot and enable images stored on the flash memory card to be displayed on the electronic display devices 110 and 115. In alternative embodiment, the memory device 120 of the digital collage display system 100 is a flash device provided within the housing 105. This flash memory device 120 is capable of receiving digital images and data, via a wired or wireless link. The digital collage display system 100 can then enable the display of the digital images, stored on the flash memory device 120, on the electronic display devices 110 and 115. Additionally, in another embodiment, the memory device 120 is a removable USB drive. The removable USB drive memory device 120 can be inserted into a USB receptacle port provided on an exemplary embodiment of the digital collage display system 100. Once the removable USB drive memory device 120 is inserted, images and data stored on the memory device 120 can be displayed on the electronic display devices 110 and 115.

In yet another alternative embodiment, the memory device 120 of the digital collage display system 100 is a hard disk drive. The hard disk drive can be provided within the housing 105 or separate from the housing 105. The hard disk drive memory device 120 can be provided in communication, via wired or wireless link, to the electronic display devices 110 and 115 to enable the display of digital images, movies, or other data stored on the hard disk drive memory 120. For this embodiment, the user is permitted to access the hard disk drive memory device 120 to upload, delete, or modify the content contained on the drive. Those of skill in the art will appreciate that the memory device of the digital collage display system 100 can be many suitable types of storage mediums provided within, or external to, the housing 105 of the digital collage display system 100.

FIG. 1B provides a block diagram of a digital collage display system 100 in communication with remote devices in accordance with an exemplary embodiment of the present invention. In an exemplary embodiment of the digital collage display system 100, the memory device 120 is enabled to receive data containing digital images and movies via one or more communication links. As shown in FIG. 1B, the digital collage display system 100 can provide a variety of different types of communication links. For example and not limitation, digital collage display system 100 can provide a Universal Serial Bus (“USB”) interface 130 as a communication link. In an exemplary embodiment, this USB interface 130 can permit a connection to be made with a USB cable between the digital collage display system 100 and a remotely located personal computer 140. Thereby, the user can connect a USB cable from his or her computer 140 to the USB interface 130 and download pictures from the computer 140 onto the memory device 120 of the digital collage display system 100. Those of skill in the art will appreciate that a variety of other different devices could be connected to the USB interface 130, such as a digital camera, camcorder, mp3 device, camera enabled cellular phone, or personal digital assistant.

FIG. 1B further illustrates that the communication link of the digital collage display system 100 can be a wireless interface. As shown in FIG. 1B, the digital collage display system 100 can provide a wireless interface 135 for connection to a remotely located device or network. In an exemplary embodiment, the digital collage display system 100 could connect to a wireless local area network device, such as wireless router 145 shown in FIG. 1B, via the wireless interface 135. In a non-limiting example, the digital collage display system 100 could be configured to automatically join wireless networks within range of the digital collage display system 100. Thereby, a user could be permitted to transmit and receive data containing digital images and movies from other computers, the internet, or other networked devices. Those of skill in the art will appreciate that the wireless interface 135 can be configured to operate under a number of different protocols such as Bluetooth®, IEEE 802.11x, or other protocols. In an non-limiting example, the user can download pictures from his or her camera enabled cellular phone onto the digital collage display system 100 via a wireless Bluetooth® communication link.

The electronic display devices 110 and 115 of the digital collage display system 100 can be dedicated to the display of digital images; thus, providing significant advantages to the user. In an exemplary embodiment, digital collage display system 100 can be hung, mounted, or positioned in a convenient and central location in the home or office. Therefore, the user is provided with a convenient and easy method of simultaneously displaying multiple images from a digital image library. In an exemplary embodiment, the digital collage display system 100 can be configured to display an album or group of images as a slideshow. Therefore, the digital collage display system 100 can provided a centrally located repository to continually display of thousands of digital images without input or attention by the user.

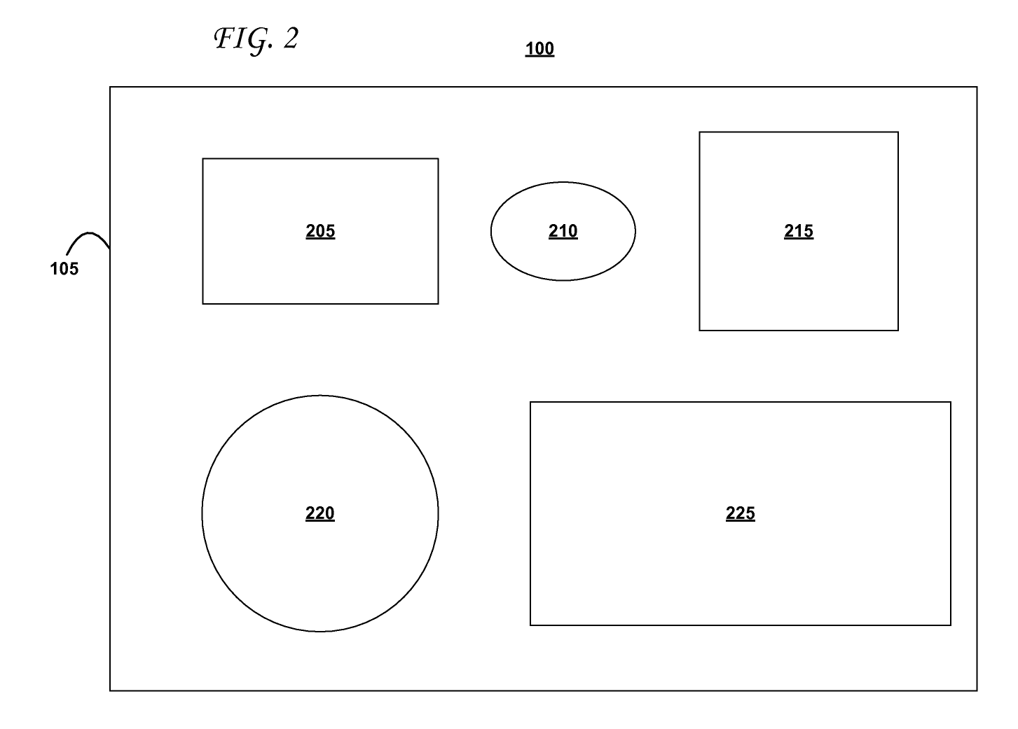

FIG. 2 provides a block diagram of a digital collage display system 100 in accordance with an exemplary embodiment of the present invention. The digital collage display system 100 shown in FIG. 2 provides a housing 105. In an exemplary embodiment of the digital collage display system 100 depicted in FIG. 2, many electronic display devices are provided. The housing 105 of the digital collage display system 100 embodiment shown in FIG. 2 includes electronic display devices 205, 210, 215, 220, and 225. Therefore, the digital collage display system 100 provides five separate electronic display devices. In the exemplary embodiment depicted in FIG. 2, the user is enabled to simultaneously display at least five independent digital images. This provides a significant advantage to the user. Notably, the user can create a collage of imagery with the exemplary embodiment of the digital collage display system 100 displayed in FIG. 2. For example, and not limitation, the user could simultaneously display multiple images from a particular event, such as a birthday party, sporting event, or family gathering. Alternatively, the user could create a collage of images relating to a certain individual or group of individuals, such as pictures of a child at various ages of childhood. Furthermore, the user could use the digital collage display system 100 shown in FIG. 2 to highlight a vacation or visit to particular city or country. Significantly, the user is enabled by the digital collage display system 100 to create a simultaneous display of large amount of imagery to tell a story or create a vehicle of artistic expression.

Additionally, in an exemplary embodiment of the digital collage display system 100, the user can configure the system 100 to cycle through images. Thus, an album can be created and the electronic display devices 205, 210, 215, 220, and 225 can transition from image to image of the album. In one embodiment, electronic display devices 205 and 210 could be held constant to display a still image, while electronic display devices 215, 220, and 225 display a slideshow of images or movies. Furthermore, as shown in FIG. 2, the electronic display devices 205, 210, 215, 220, and 225, can be different sizes. Thus, one electronic display device can be configured to display large images, while others can be configured to display small images.

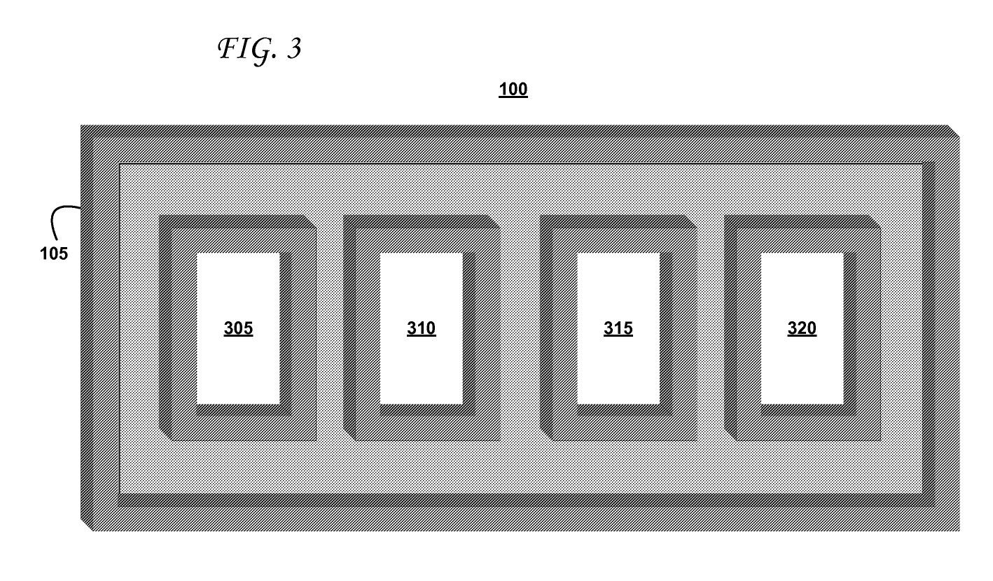

FIG. 3 provides a perspective view of a digital collage display system 100 in accordance with an exemplary embodiment of the present invention. As shown in FIG. 3, the housing 105 can resemble standard picture frame. The picture frame housing 105 shown in FIG. 3 can be made out of wood, molding, aluminum, MDF, or many other suitable materials. As shown, the housing 105 of the digital collage display system 100 can provide an attractive aesthetic. In an exemplary embodiment, the picture frame housing 105 can be hung from a wall in a manner similar to a conventional picture frame. Therefore, the digital collage display system 100 shown in FIG. 3 can be centrally located in home or office in an highly visible location.

As shown in the exemplary embodiment shown in FIG. 3, the digital collage display system 100 can provide multiple electronic display devices. In the exemplary embodiment shown in FIG. 3, the digital collage display system 100 provides four electronic display devices, 305, 310, 315, and 320. These electronic display devices, 305, 310, 315, and 320, can be provided in communication with a memory device and thereby be enabled to display digital images or movies stored on the memory device.

In an exemplary embodiment of digital collage display system 100, the user is provided with an interface tool. For example, and not limitation, the user can connect to the processor of the digital collage display system 100 via a communication link and execute software to determine the sequence of photos and transitions to be illustrated by the electronic display devices, 305, 310, 315, and 320. In one example, the user can configure each of the electronic display devices, 305, 310, 315, and 320, to display a single image for a certain time period and then transition to a new image. The image changes can be configured by the user to either be random or pre-programmed. For instance, a series of images may have a particular chronological order and the user can configure the images to transition in chronological order. In an alternative example, the user could configure an image to transition from one electronic display device to another to create a scrolling effect.

Those of skill in the art will appreciate that the electronic display device used in various embodiments of the digital collage display system 100 can be many different types of display devices suitable for displaying digital images. For example, the electronic display device can be a Liquid Crystal Display (LCD) device commonly used for computer monitor. In an alternative embodiment, the electronic display device can be a plasma device capable of displaying images and movies. Additionally, the electronic display device can be many suitable types of display devices, including a Cathode Ray Tube (CRT) device, field emission device, other television device, other computer monitor device, and other electronic display devices that provide a convenient method to display multiple digital images and movies.

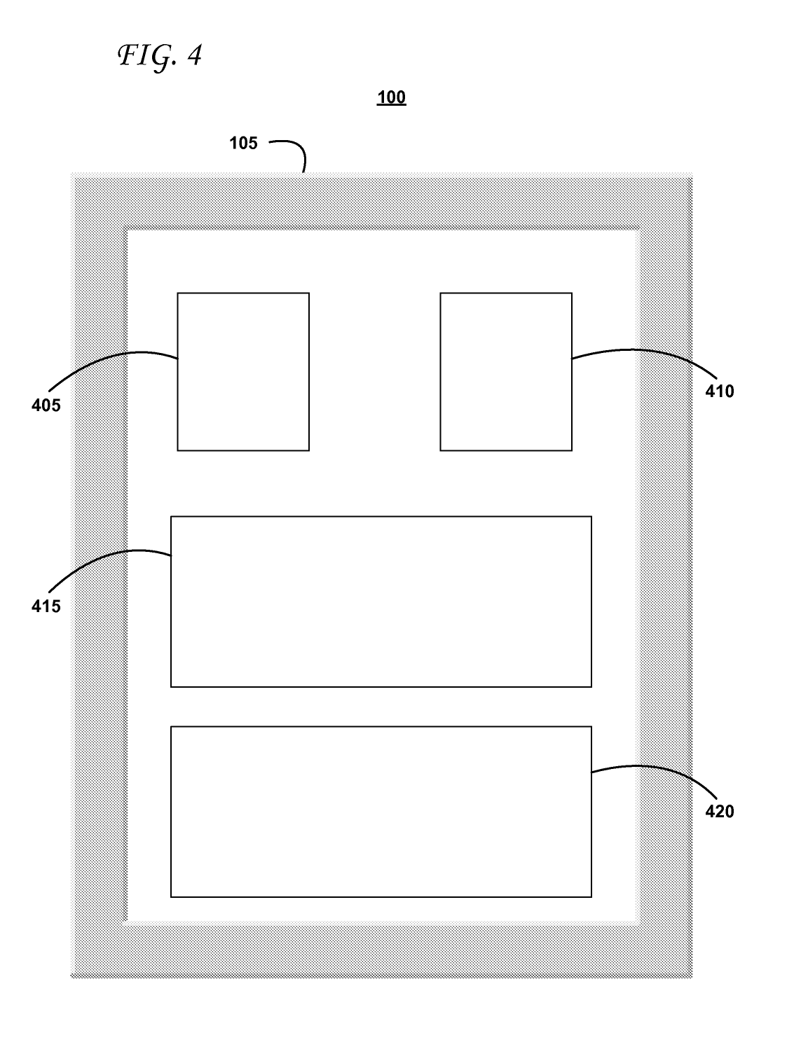

FIG. 4 provides a perspective view of a digital collage display system 100 in accordance with an exemplary embodiment of the present invention. As shown in FIG. 4, the digital collage display system 100 can be provided in a vertically oriented frame. Furthermore, the digital collage display system 100 can be provided with a varying number of electronic display devices. As shown in FIG. 4, the housing 105 provides an enclosure for electronic display devices, 405, 410, 415, and 420. These electronic display devices, 405, 410, 415, and 420 can be configured to simultaneously display a variety media, including images and movies.

In an exemplary embodiment, digital collage display system 100 can provide a number of controls and ports that can be easily accessed by the user. The controls and ports can include a power cable input port, a data communication port and a display control panel. The data communication port can be enabled to receive input from digital imaging equipment or a memory device, such as a computer, a digital camera, camcorder, or other camera phone. Additionally, the power cable input port can receive a power input for the electronic display devices, 405, 410, 415, and 420. The display control panel can allow the user to adjust the video and or audio settings of the electronic display devices, 405, 410, 415, and 420.

In an alternative embodiment, the digital collage display system 100 provides memory card slots on the periphery of the housing 105. For example, the digital collage display system 100 can be configured to receive flash memory cards from digital cameras and display the images or movies stored on those flash memory cards.

In an alternative embodiment of the present invention, digital collage display system 100 does not provide any memory devices or processing devices. In this embodiment, the electronic display devices are enabled to receive data input from a device outside the digital collage display system 100. In this embodiment, communication wiring can be discretely routed to the electronic display devices to provide an input feed or communication can be established over a wireless link.

Those of skill in the art will appreciate that many features and accessories can be added to the digital collage display system 100 without detracting from the scope of the invention. For example, and not limitation, the digital collage display system 100 can be configured to include a clock, an alarm, a calendar, a radio, an MP3 device, and/or other media player. Furthermore, the digital collage display system 100 can be configured to provide a storage unit within the system 100. Additionally, the structure of the digital collage display system 100 can be configured for various applications. For example, and not limitation the digital collage display system 100 can be configured as a flat plane system or can also be configured as a multi-dimensional system.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A digital collage display system comprising:
a housing;
a first electronic display device in communication with the housing;
a second electronic display device in communication with the housing;
a memory device in communication with the first electronic display device and the second electronic display device; and
wherein the first electronic display device and the second electronic display device are enabled to display a plurality of digital images stored on the memory device.

2. The digital collage display system of claim 1, wherein the first electronic display device and the second electronic display device are configured within the housing.

3. The digital collage display system of claim 1, further comprising a processor enabled to retrieve a portion of the plurality digital images stored on the memory device and permit the display of a portion of the plurality digital images on the first electronic display device and the second electronic display device.

4. The digital collage display system of claim 3, wherein the single processor and the single memory device enable the display of the plurality of digital images on both the first electronic display device and the second electronic display device.

5. The digital collage display system of claim 1, further comprising a third electronic display device in communication with the housing, wherein the third electronic display device is enabled to display a plurality of digital images stored on the memory device.

6. The digital collage display system of claim 1, wherein the memory device is enabled to receive a portion of the plurality of digital images via a communication link.

7. The digital collage display system of claim 6, wherein the communication link is a Universal Serial Bus interface.

8. The digital collage display system of claim 6, wherein the communication link is a wireless link.

9. The digital collage display system of claim 6, wherein the communication link is connected to a personal computer.

10. The digital collage display system of claim 1, wherein the memory device is enabled to receive a flash media card from a digital camera.

11. The digital collage display system of claim 1, wherein the housing is enabled to be mounted on a wall.

12. A method of creating a digital image collage comprising the steps of:
providing a housing having a first electronic display device and second electronic display device;
providing a memory device in communication with the first electronic display device and the second electronic display device; and
displaying a plurality of digital images stored on the memory device on the first electronic display device and the second electronic display device.

13. The method of creating a digital image collage of claim 12, further comprising the step of processing the plurality of digital images stored on the memory device with a processor to enable the step of displaying the plurality of digital images.

14. The method of creating a digital image collage of claim 12, further comprising the step of receiving the plurality of digital images stored on the memory device from a remote device.

15. A system comprising:
a housing;
a processor configured within the housing;
a memory device for storing a plurality of digital images configured within the housing;
at least a first electronic display device and a second electronic display device configured within the housing; and
wherein the first electronic display device and the second electronic display device are enabled to display the plurality of digital images.

16. The system of claim 15, further comprising a third electronic display device configured within the housing, wherein the third electronic display device is enabled to display the plurality of digital images stored on the memory device.

17. The system of claim 15, further comprising a communication link enabled to receive a portion of the plurality of digital images to be stored on the memory device.

18. A picture frame comprising:
a first electronic display device;
a second electronic display device;
a memory device in communication with the first electronic display device and the second electronic display device; and
wherein the first electronic display device and the second electronic display device are enabled to display a plurality of digital images stored on the memory device.

19. The picture frame of claim 18, wherein memory device is enabled to receive a portion of the plurality of digital images via a communication link.

20. The picture frame of claim 19, wherein the communication link is a wireless link to a local area network.
